(19) United States
(12) Patent Application Publication
(10) Pub. No.: US 2008/0029334 A1
(43) Pub. Date: Feb. 7, 2008

(54) LOW-FREQUENCY ACOUSTIC WAVES FOR COLLECTING AND/OR MOVING PARTICLES INSIDE ARTICLES

(75) Inventors: Robert Landon Roach, Ramat Hasharon (IL); Beni Nachon, Qiriat-Ata (IL); Rafi Zchout, Givatayim (IL)

Correspondence Address: MILDE & HOFFBERG, LLP, 10 BANK STREET, SUITE 460, WHITE PLAINS, NY, 10606, US

(73) Assignee: TRACEGUARD TECHNOLOGIES INC., New York, NY (US)

(21) Appl. No.: 11/751,314

(22) Filed: May 21, 2007

Related U.S. Application Data
(60) Provisional application No. 60/802,170, filed on May 22, 2006.

(51) Int. Cl. G10K 15/04

(52) U.S. Cl. 181/142

(57) ABSTRACT

A system and method for collecting, mixing and/or extracting particles from within an article, e.g., by size or density, including the steps of applying a sound wave to the article, whereby the sound wave disperses particles throughout the article, and optionally transporting and/or collecting the particles from the article. This system and method is useful for applications that require noninvasive methods to effect the movement of particles within articles that may contain materials such as solids, fluids, and/or gases.

### FIELD OF THE INVENTION

The present invention relates to moving particles inside articles and, in particular, to a system and corresponding method that employs acoustic waves to move particles inside articles. The present invention is greatly useful for applications that require noninvasive methods to effect the movement of particles within hermetically sealed articles that may contain materials such as solids, fluids, and/or gases. In addition, the present invention is useful for collecting and/or extracting and/or arranging particles within non-hermetically sealed and hermetically sealed articles.

### BACKGROUND OF THE INVENTION

Low frequency acoustic energy creates air pulses that can travel great distances in still air. When generated at close proximity to a article, the acoustic energy induces vibration of the exterior shell of the article, causing the wave to continue propagating within the article. Thus, the wave easily penetrates the article.

In a preferred embodiment of the present invention, the term “article” refers particularly to any handling and/or storing device, including, but not limited to, a container, bag, can, parcel, box, packet, or their equivalents.

The term “standing waves” refers to a phenomenon that occurs as a result of interference between at least two waves of identical frequency traveling in opposite directions. The wave nodes are fixed in space as the waves propagate within the medium.

The term “subwoofer” refers to a sound source which reproduces bass frequencies below 200 Hz and preferable below 20 Hz, i.e. in the infrasound range below that of human hearing.

There is thus a need for, and it would be highly advantageous to have a method and system for collecting particles from an article using sound waves. It is also desirable to have a method and system for mixing material stored in at least one container using sound waves.

Moreover, there is a need for, and it would be highly advantageous to have a method and system for moving particles within an article using sound waves from a source completely outside of the article.

Furthermore, it is desirable to have the method and system for separating materials based on their density, by applying a standing sound wave.

### SUMMARY OF THE INVENTION

The present invention relates to moving particles inside articles and, in particular, to a system and corresponding method that employs acoustic waves to move particles inside articles.

The present technology provides systems and methods for collecting and/or moving particles within enclosed articles using sound waves.

The present technology also provides systems and methods for arranging particles within sealed articles by size, and/or for separating particles of different sizes, using sound waves.

The present technology further provides systems and methods for influencing the position of particles within an article through remote means completely outside of the article.

The method of the present technology is generally applicable as a “stand-alone” particle collection system, or, as a particle collection system used for trace detection.

Implementation of the method and corresponding system of the present technology involves performing or completing selected tasks or steps manually, semi-automatically, fully automatically, and/or a combination thereof. Moreover, depending upon actual instrumentation and/or equipment used for implementing a particular preferred embodiment of the disclosed system and corresponding method, several embodiments of could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing various computer programs having software instructions, or protocols using any suitable computer operating system.

The acoustic system may include a single active element, which will generally interact with at least one additional active or passive element. For example, a resonator requires a “reflector” acoustic element, which may be a properly physically spaced acoustically reflective structure to achieve a desired phase alignment demonstrating constructive interference, or an actively controlled structure which achieves a controllable phase difference without requiring a precise physical displacement, and therefore which potentially has reduced length.

The acoustic transducer, for example, is an electromagnetic-acoustic transducer which imparts movement to an air column by moving a cone or piston structure. On the other hand, large amplitude air movement, and corresponding large pressure variation, can be achieved by using a modulated pressurized air source or a relatively large volume reciprocating piston which is moved, for example, by a motor.

The present invention may be employed to move or transport particles after they have been extracted from an article, and for example, which may settle on the walls of a chamber. Typically, it is desired to impose sufficiently large forces on the particles at the wall, to detach them and suspend them in an air flow. Since the acoustic waves generally have a nodal pattern, it is advantageous to sweep the walls with a time-varying acoustic wave pattern. Typically, the time variation will involve phase shifts, but these may be accompanied by frequency shifts and/or waveform variations as desired or necessary to supply the necessary forces at or near the wall. In order to generate wall forces, typically the acoustic wave will be established transverse to the wall, with the nodal plane of the wave appearing as a line on the wall which has minimum pressure variations or particle movements, which is then tuned to move the nodal plane along the wall. Based on the shape of the chamber and location of transducer(s), generating sufficient wall force on all portions may require using different frequencies and/or complex waveforms and/or different transducers. Typically, the particles of interest will selectively aggregate on certain walls, an therefore the chamber need not be designed to provide equal treatment to all portions. Likewise, adaptive control may be provided to selectively sweep wall portions which have particulates on them, and to control the treatment.

It is therefore an object to provide a device comprising at least one sound source, at least one chamber adapted to hold an article, whereby said at least one sound source causes fluid movement within said at least one article, and said fluid movement induces movement of particles within the article.

It is also an object to provide a method for collecting particles from an article, the method comprising the steps of applying a sound wave to the article, whereby said sound wave disperses particles throughout the article, and collecting particles from the article.

It is a further object to provide a method for collecting particles from an article, the method comprising the steps of defining at least one particle concentration area and at least one sound source location; calculating at least one sound source operating frequency; calculating a phase angle of said sound source with respect to the at least one frequency; and operating said sound source to preferentially collect particles at the at least one particle concentration area.

It is a further object to provide a method for collecting particles from an article, the method comprising the steps of defining a particle concentration area, setting at least one operating acoustic frequency of a sound source, calculating respective locations of a plurality said sound sources, whereby the anti-nodes of the sound waves at the at least one acoustic frequency are superposed are at the desired locations, placing said sound sources at the calculated respective locations, and operating said sound sources at the at least one operating acoustic frequency.

Another object provides a method for collecting particles, comprising the steps of defining at least one particle concentration area and an acoustic transducer configuration, calculating at least one set of acoustic transducer configuration operational parameters for producing an acoustic wave pattern in the at least one particle concentration area, adapted to transport at least one particle, and operating the acoustic transducer configuration in accordance with the calculated set of acoustic transducer configuration parameters, to preferentially concentrate particles at the at least one particle concentration area.

The particles may be collected or extracted by a respective particle collection or extraction system, which may be separate or combined. The collected particles may be transported to and/or analyzed by a trace detection or analysis system. The step of collecting particles may comprise swabbing said article in order to pick up particles, using a suction device, transporting the particles within an air flow, or the like. The step of collecting particles may comprise a physical contact between a particle collector and the article, or use of non-contact means, such as air flows.

The article may be unsealed, non-hermitically sealed or hermetically sealed. The article may comprise at least one compartment, and the at least one compartment may be hermetically sealed when said device causes said fluid movement within said article. The compartment is preferably opened to permit particles to exit the compartment, though if the compartment remains closed during treatment, the particles may be moved or mixed therewithin. The sound source may, for example, produce frequencies below 20 Hz, in the range of 20 Hz to 20 KHz, and/or frequencies above 20 KHz.

The sound source may concentrate some of said particles towards at least one particle collection component of said particle collection system. The sound source, for example, may concentrate particles towards a predefined location, a varying location selected or controlled by the system, or a plurality of locations. The device may further comprise a particle-dispersion device, comprising at least one of: a heater, a shaker, a radiator, a radiation source, a frictional component, an electrostatic component, a field producing component, and an electronic excitation energy device. The method may further comprise the steps of heating, a shaking, radiating, electrostatic charge generation or dissipation, frictional effects, producing a field, and electronically exciting. The method may further comprise at least one treatment using a heater, a shaker, a radiator, a radiation source, a frictional component, an electrostatic component, a field producing component, and an electronic excitation energy device.

The device may also comprise a pressurizing device for increasing an air pressure in the chamber, and/or a depressurizing device for decreasing an air pressure in the chamber. Such devices may be, for example. Valves connected to a pressure source or vacuum chamber. If the chamber I operating at super- or sub-atmospheric pressure, the depressurization may be to ambient pressure.

The step of collecting particles may also comprises pressurizing and depressurizing the article in order to move particles out of the article. The step of applying the sound wave may advantageously be synchronized with the step of collecting particles. The sound wave may comprise a moving pressure wave. The sound wave may concentrate particles towards a predefined or variable particle collection location, and the particle collection step may, in some instances, selectively acquire particles from the particle collection location.

The method may also include the steps of observing the actual location to which the particles move, and correcting at least one of the parameters affecting the sound wave to alter the actual location. The method may further include the step of auto-calibrating the sound wave by controlling the phase and frequency of the sound wave. The method may also comprise the step of observing the actual location to which the particles move, and correcting at least one of said operating frequency and said phase angle. The method may also comprise the step of defining a sound source output waveform, and modifying the sound source output waveform to alter the collection of particles. The method may further comprise the step of observing the actual location to which the particles preferentially move, and recalculating the respective locations of the sound sources and relocating at least one of the sound sources according to the calculation. The method may also further comprise the step of observing the actual location to which the particles preferentially move, and altering at least one of the defined particle collection area, the at least one operating acoustic frequency, and the respective locations of the sound sources in dependence on the observation.

The method may distinguish between particles having different characteristics, and the step of collecting particles from the article may preferentially collect particles having a predefined characteristics. The article may comprise at least one hermitically sealed compartment, which may be opening before, during or subsequent to the treatment. A compartment in the article may also be non-hermetically sealed, and may be permeable to acoustic waves and/or particles.

Another object provides a low frequency sonic wave mixer for moving a material within at least one article, comprising at least two acoustic elements which may be passive (e.g., a reflector or resonator) or active (e.g., a transducer or modulated pressure and/or vacuum source), for selectively producing an acoustic field within the article, and a control for operating the at least one acoustic element to induce a flow of material within the article.

A further object provides a method for mixing material within an article comprising the steps of providing t at least two acoustic elements for selectively producing an acoustic field within the article, and controlling at least one of the acoustic element to induce a flow within the material.

A still further object of the invention provides a method for separating materials in an article comprising the steps of controlling the phase of at least two sound sources, whereby said sound sources apply a standing sound wave to said materials, and causing the standing wave to move within said article.

The sound wave mixer may be used for re-distributing particles of said material. The sound wave mixer may also be used for preventing sedimentation of said material. The material may comprise a plurality of distinct substances, and said sound wave mixer is used for mixing said plurality of distinct substances, whereby said mixing counters the effects of differentiation by settling. The article may comprise at least one compartment and said at least one compartment is in its closed state when said at least two acoustic elements produce the acoustic field. The at least two acoustic elements may be used to produce an acoustic field having nodal planes resulting from frequency components below 20 Hz, and/or and/or 20 Hz to 20 kHz and/or greater than 20 kHz. The method may further comprise the steps of heating, a shaking, radiating, electrostatic charge generation or dissipation, frictional effects, producing a field, and electronically exciting. The method may further comprise at least one treatment using a heater, a shaker, a radiator, a radiation source, a frictional component, an electrostatic component, a field producing component, and an electronic excitation energy device. The materials may have differing density and/or size, and the step of moving the standing wave within the article may separate the materials based on their density and/or size.

### BRIEF DESCRIPTION OF THE DRAWINGS

The present invention is herein described, by way of example only, with reference to the accompanying drawings. With specific reference now to the drawings, it is stressed that the particulars shown are by way of example and for purposes of illustrative discussion of the preferred embodiments of the present invention only, and are presented in order to provide what is believed to be the most useful and readily understood description of the principles and conceptual aspects of the present invention.

In this regard, no attempt is made to show structural details in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIG. 1 is a schematic diagram illustrating a first embodiment;

FIG. 2 is a schematic diagram illustrating a second embodiment of a trace collection system;

FIG. 3 is a schematic diagram illustrating a third embodiment of a trace collection system;

FIG. 4 is a flow diagram of an embodiment of a first method for moving particles within an article; and

FIG. 5 is a flow diagram of an embodiment of a second method for moving particles within an article.

### DETAILED DESCRIPTION

The present invention relates to moving particles inside articles and, in particular, to a system and corresponding method that employs acoustic waves to move particles inside articles. The present technology is greatly useful for applications that require noninvasive methods to effect the movement of particles within hermetically sealed articles that may contain materials such as solids, fluids, and/or gases. In addition, the present technology is useful for collecting and/or extracting and/or arranging particles within non-hermetically sealed and hermetically sealed articles.

The present technology may be used as a system and a method for moving and collecting particles. The preferred embodiments are discussed in detail below. It is to be understood that the present invention is not limited in its application by the details of the order or sequence of steps of operation or implementation of the method and/or the details of construction, arrangement, and composition of the components of the system set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The present invention is capable of other embodiments or of being practiced or carried out in various ways. Also, it is to be understood that the phraseology, terminology and notation employed herein are for the purpose of description and should not be regarded as limiting.

The present invention is preferably operated using low frequency acoustic transducers, e.g., subwoofers, but it is to be understood that in the case where there is no barrier between the wave source and the article interior, the present invention may be operated with sound waves of about 90 Hz or more, so long as the sound wave frequency is suitable for the article under investigation/maintenance. Moreover, it is to be understood that when the acoustic source is part of the article walls, virtually any frequency may be used.

In one embodiment, a sound source, e.g. a subwoofer, reproduces the lower end of the audio spectrum to create air fluid flows both inside and around at least one article. Subsequently, some particles loosen and/or are entrained, causing them to move within the article. Similarly, it should be possible to preferentially cause such flow to predictably move particles in almost any desired trajectory.

In one embodiment, the article may contain a suspected material and the fluid flows within the article cause all or a portion of the suspected material to flow, for example to or outside the periphery of the article.

In one embodiment, the aforementioned article has at least one compartment. The at least one compartment may feature a “hermetically sealed” state, and a “non-hermetically sealed” state.

One embodiment uses low frequency “acoustophoresis”. Low frequency sound waves are able to penetrate an article more easily than higher frequencies, since higher frequencies are increasingly damped by the article walls, and optionally an outer container. The present technology may be used in combination with other particle dispersion methods such as heating, shaking, and/or radiating. In a preferred embodiment the distortion of the sound wave as it passes through the article is slight. Hence, the article represents only a small attenuation element in the surrounding field. The acoustic field is of great advantage since it exerts forces on the items within the article. A wide range of forces and force directions are possible. Moreover, since the acoustic frequency can be selected to be below the range of human hearing, strong sound pressure levels may be used without creating a noise hazard. It is to be understood that the present technology may transmit sound wave frequencies in a variety of ranges, such as, but not limited to, frequencies below 20 Hz, frequencies in the range of 20 Hz to 20 KHz, and frequencies above 20 KHz.

It is also understood that the acoustic energy may be generated by one or more transducers, with or without a resonator, and indeed the transducer system may comprise an array of transducers, for example a selectively disposed spatial array which is adapted to permit control over the spatial acoustic fields and forces imposed on the article. The control system therefore may comprise a digital signal processor for defining a desired spatial and temporal acoustic field pattern, a spatial array of electro-acoustic transducers, and optionally an acoustic feedback system, e.g., one or more microphones (acoustic-electric transducers) and optionally a controllable and/or tunable resonator chamber.

Therefore, in accordance with this embodiment, the peak acoustic power at a selected spatial position, typically at the wall or, or within, the article may be significantly higher than the peak acoustic power available from any one transducer, and the characteristics of the acoustic field may be finely controlled. For example, it may be desired to induce a macroscopic movement in a wall of an article having a compliant wall, to induce air flows therein. Thus, the external acoustic field is defined by the processor to induce a pressure differential across the wall of the article. Since the article has a volume, the acoustic transducer array may also optimize the acoustic fields for the various walls of the article, to induce the desired flow pattern. Likewise, the wall of the article may be transparent or translucent to acoustic waves, permitting the acoustic transducer(s) to define the acoustic field within the article, directly. In that case, the acoustic field within a chamber holding the article may be defined. More commonly, the article will interact with the acoustic field, with a part of the acoustic energy being transduced to a wall or other structures of the article, part passing though any walls, and part being absorbed. Accordingly, the acoustic frequencies, spatial acoustic field characteristics, mass air flows, may all be optimized based on various criteria. The range of these criteria may be a single global optimum, a classified optimum (i.e., where the article is classified into one of a limited number of classes, and a treatment applied with is optimized for that class), a model-based optimum (i.e., where a “type” and parameters of the article are determined, and these are applied to a model of the “type” to determine the treatment), a feedback-based optimum (i.e., where a sensor determines an effect of the treatment, and the acoustic fields modified seeking to achieve a desired effect or condition), or the like.

In some cases, it may be desired to efficiently deposit energy in certain parts of the article; for example, it is desired to transmit energy though a wall of the article, and then absorb or transducer that energy therein. This can be accomplished in a number of ways. One way is to exploit non-linear properties of materials which, for example, can self-modulate or inter-modulate a plurality of waves. Thus, as the waves enter the article, harmonics or inter-modulation products are generated, which can have vastly different acoustic absorption properties in the surrounding materials.

The acoustic field need not be static or have nodal planes with static locations, and in fact, the acoustic field may change dynamically, to scan the article or induce a net movement thorough or out of the article.

While the technology is generally discussed with respect to the sampling of particle within articles, it should also be understood that the technology may also be used to emplace particulates within an article or object. For example, it maybe desirable to disperse an insecticide or biocide within an article; therefore, the technology may be used to bring external particles within the object. Likewise, it may be desirable to tag an article and its contents with a taggant.

In a preferred embodiment, particles are extracted from articles when examining for contraband substances. The examination of articles for contraband substances, such as, but not limited to, explosive materials, narcotics, and biological agents, may include analyzing trace particles collected from the article. The acoustic waves may be used not only to move particles within an article, but also after they are transported out of the article. Analyzing trace particles is well known in the art of security screening services.

The present technology discloses a device and corresponding method for collecting particles from within articles, and optionally from within (hermitically or non-hermetically) sealed articles. It is to be understood that in order to collect particles from a hermetically sealed article, the article has to be opened. This may be in contrast with collecting particles from a non-hermetically sealed article, which may be opened or may remain closed in order to collect particles from within it.

Various trace detection systems require that articles be non-hermetically sealed and usually opened in order to collect particles from within the articles. This results in article delivery delays and long lines at transportation embarkation sites as carry bags and other articles must be laboriously examined for contraband. It is a great advantage of the present invention to be able to collect trace particles from within nonhermetically sealed articles without having to open them.

In another embodiment, the sound sources of the present invention enhance various types of inspection systems, where articles are opened for inspection, such as methods where the interior surface must be “swabbed” and the swab is subsequently placed in a trace analyzer. According to this embodiment, using the sound waves effectively disperses particles throughout the article so that the probability of the swab to pick up any searched for particles is significantly increased.

Moreover, means of particle extraction from articles using “breathing” techniques, where pressurized air enters an article and, upon leaving the article, carries with it particles from within the article are known. This method works well when the particles are subject to the forces exerted by the pressurized air, and the air dilution of the sample is acceptable. For example, if particles are stuck to a surface or exist on the lea side of objects within the article, they may remain out of touch of the airflow and hence not be removed from the article.

Another preferred embodiment uses low frequency sound waves to extract particles from the article using the “breathing” method described above.

Low frequency acoustic waves may penetrate the article, causing air currents to induce particle motion. The air currents can lift particles that are stuck to their surface and otherwise move particles to locations where they are susceptible to being entrained for extraction by “breathing” air currents.

Creating air currents increases the probability that particles within the articles dislodge and subsequently become more susceptible to motion caused by air movement inside the inspected luggage. This improves the detection probability of a particle collection system, since the particles are more distributed across the article interior (i.e. near article openings) and are more likely to be extracted during a breathing cycle. The timing of the generation of low frequency waves can therefore be in accordance with other activities of the trace collection system, so as to improve system performance. Advantageously, the control system for the acoustic process may be integrated or communicate with the control system for a particle extraction and analyzing system, in order to coordinate functions sand pass information.

Using sub-audible acoustic frequency sound waves is advantageous since they are less detectable by the human ear, and do not present a public health hazard. The frequency of the sound pressure levels (for example, standing waves) can be tuned to be undetectable by animals in the proximity of the trace collection system. The at least one sound source may be located almost anywhere around the inspected articles. As is known in the art, sound sources, including subwoofers, may be made to be directional. Using a directional sound source further reinforces the aforementioned significant particular aspect of novelty and inventiveness of the present invention, relating to the ability to locate the sound sources almost anywhere around the inspected article.

Steps, components, operation, and implementation of using acoustic waves for moving particles inside articles, according to the present invention, are better understood with reference to the following description and accompanying drawings.

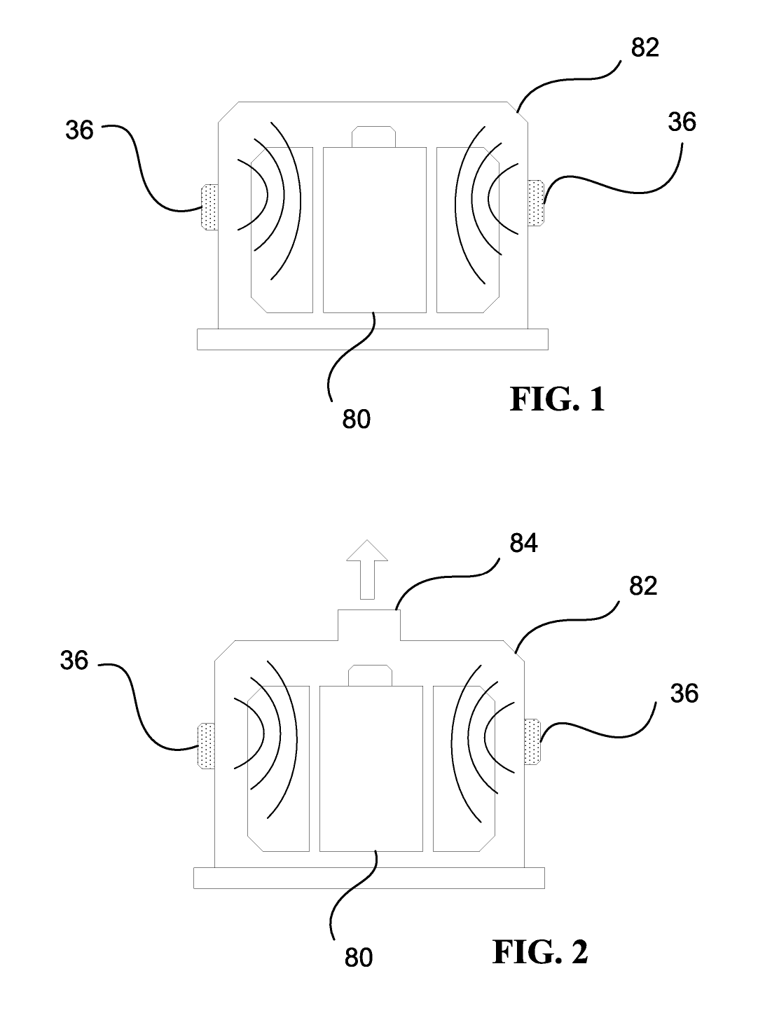

Referring to FIG. 1, the trace collection system features the following components: inspected article 80, sound sources 36, and particle collection system 82. At least one sound source 36 creates low frequency sound waves that loosen particles and diffuse them from inside to the periphery of inspected articles 80. Optionally, particle collection system 82 conveys the collected particles to a collector and/or to an analysis unit.

In another embodiment, acoustic resonators that produce high intensity sound waves control the trajectory of particles, i.e. using moving sound pressure levels to move particles inside an article. In an alternative or additional phrasing, this embodiment discloses the ability to concentrate particles in the vicinity of a predefined three-dimensional location. As known, the generation of standing sound waves causes particles to concentrate in the wave's trough. This is due to a force created by unequal sound pressure levels (SPL) across the standing wave that pushes the particle toward the low pressure point. The term “moving sound pressure levels” refers to moving standing waves.

In one embodiment, a sound source, e.g. a subwoofer, which reproduces the lower end of the audio spectrum, is used to create moving sound pressure levels for moving particles both inside and around the inspected articles. Moving sound pressure levels are utilized to dislodge particles, augment particle trajectory, and move particles in a predefined direction, e.g. towards the location of particle inhaling components of the particle collection mechanism. This improves the reliability of the collection process since more particles are extracted from the inspected articles, collected and analyzed.

Using moving sound pressure levels for moving particles inside the luggage can improve on other vibrating mechanisms that instigate the movement of particles in the inspected articles. The timing of the generation of moving sound pressure levels can be in accordance with other activities of the trace collection system so as to improve system performance.

In one embodiment, the inspected article is pressurized so air gets into it by applying the following two steps: (1) applying long waves that move particles from the middle of the inspected article toward article openings. (2) “breathing” in order to take the particles out of the article. It should be noted that there may be circumstances in which the breathing is not necessary if the particles can be removed from the article by using the first step only.

As described above, breathing refers to pressurizing the article within a flexible enclosure and then depressurizing the article. When pressurizing the article, air flows into the article, referred to as inhaling. When depressurized, the air quickly exits the article carrying with it trace particles of whatever was in the article. This is referred to as exhaling. Thus, the inhaling and exhaling is called “breathing.” Of course, it is also possible to provide a unidirectional air flow, or an oscillating or modulated unidirectional flow, rather than a bidirectional flow.

A significant particular aspect relates to moving particles toward openings of an article using moving sound pressure levels. Referring to FIG. 2, a trace collection system features the following components: inspected articles 80, sound source 36, particle collection system 82, and particle inhaling component 84. At least one sound source 36 creates low-frequency sound waves that form moving sound pressure levels. Moving sound pressure levels loosens particles and diffuses them from the inside to the periphery of inspected articles 80. The moving sound pressure levels move the particles inside particle collection system 82 towards at least one particle inhaling component 84. The trace collection system then conveys the extracted particles to an analyzer.

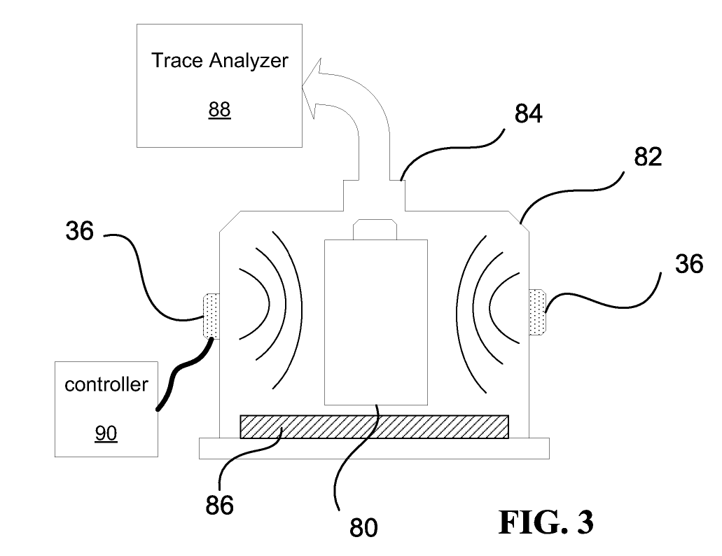

Referring to FIG. 3, the device may further include a particle-dispersion device having at least one of the following elements: shaker or other bulk motion inducing element including translation, rotation, and vibration, cooler, heater, radiator, radiation source, frictional component, electrostatic component, field producing component, and electronic excitation energy device, referred to as particle dispersion device 86. Particle dispersion device 86 may be located in any reasonable place, and optionally within particle collection system 82. Optionally, the collected particles are forwarded to trace analyzer 88. The operation of particle collection system 82 and/or particle dispersion device 86 and/or particle inhaling component 84 and/or sound source 36 and/or any other mechanism may be controlled by controller 90 as known in the art.

The creation of standing sound waves is known in the art, and generally such known devices may be used in accordance herewith. The sound sources can be located at a distance apart that is an integer multiple of the wavelength, or may be located in any required distance as long as the sound sources reconstruct the shape of the required sound wave. However, integer distances are not required to create a standing wave. If opposing sound sources using the same frequency tune their phases properly, then a standing wave may be produced using virtually any distance between the sources.

The system may be auto-calibrated by controlling the phase and frequency of every sound source. This provides a relaxation of the requirements that constrain the spread and material of the sound source, thus auto-calibration can reduce system cost.

A preferred embodiment of such an arrangement would be a low frequency acoustic source, such as a subwoofer, at close proximity to an article, which transmits acoustic waves into the article. The waves pass through the walls and through the interior of the article. This induces a unidirectional force pushing particles toward the opposite end. Particles with differing weights are forced apart as the heavier ones are pushed aside the lighter ones and accumulate at the furthest reaches of the article.

In another embodiment, a low frequency acoustic source, such as a subwoofer, at close proximity to the article, transmits acoustic waves into the article. The waves pass through the walls and through the interior of the article. This induces a unidirectional force pushing particles toward the opposite end. Materials with differing densities will be forced apart as the denser ones will push aside the less dense ones and accumulate at the furthest reaches of the article.

By using moving standing waves, the present technology is able to separate between particles that have different weight and/or dimension. This is useful for a variety of needs requiring sorting by size and/or weight.

In another embodiment, the low frequency acoustic waves are used for mixing different materials within a hermetically sealed article. According to this embodiment, suitably arranged acoustic sources are placed around the at least one article and transmit acoustic waves into the at least one article. The waves are arranged in such a way as to induce flows within the material (solid, liquid or gas) that cause materials within the article to mix. Mixing materials within an article is useful for a variety of applications.

For example, it is possible to create waves and move particles inside an article by arranging the placement of the sound sources and by controlling the wave phases. It is to be understood that the method can be used to create virtually any waveform.

There are cases where it is difficult to agitate the particles into motion, or cases where the article or content is fragile, requiring controlled agitation. Low frequency acoustic agitation is useful in such cases, since it is convenient and easy to configure and control.

According to another optional embodiment, the low frequency system is used to mix materials. For example, industrial mixers mix one container of paint at a time; in order to mix large quantities of paint, a very large shaker is needed. By using the present invention, an entire crate of paint or containers of paint may be mixed by using low frequency wave generator mixer without the need of large mechanical apparatus.

Alternatively or additionally, the system of the present invention may be used for preventing sedimentation during long-term storage. According to this case, several low frequency acoustic sources, such as subwoofers, are located in close proximity to the article, and/or within a warehouse/storage enclosure, and transmit acoustic waves into the article. The acoustic waves, which pass through the walls and through the interior of the article, induce material flow. The induced material flow transports particles in the direction of the material flow. As the material flow turns around objects within the article, turn when nearing the walls of the article, the particles mix, and may equally disperse within the article.

In another embodiment of such an arrangement, several low frequency acoustic sources, such as subwoofers, located in close proximity to the article, transmit acoustic waves into the article. The waves pass through the walls and through the interior of the article. This induces material flow that causes the differing materials to move and mix, as if they are being stirred with each other.

In another embodiment, the low frequency waves are used for re-distributing particles within a hermetically sealed article. For example, coagulated liquids, such as blood, are frequently placed in centrifuges to separate the constituent species by density. The centrifuge sets up a force gradient causing an efficient separation of differing elements (since they have different densities) for later extraction of one or more of the constituents. However, there are coagulant fluids containing delicate substances, such as certain living cells, which cannot endure the rigors of centrifugal acceleration, and other means must be used for constituent separation. The present invention disclosed a method that is able to separate the different elements without applying centrifugal acceleration. According to this embodiment, properly aligned, low frequency acoustic moving standing wave energy is made to set up a pressure gradient field within the article to allow migration of heavier species to one side or another.

In order to obtain particle separation, the various sound sources have to be synchronized. If there are two sound sources operating in a fundamental frequency, i.e. the first mode, it is required that the minimum pressure be formed along a line towards the particles to be pushed to. In order to concentrate the particles in a predefined radius, more that two sound sources, for example four sound sources, need to be applying low frequency waves. By changing the phase of the sound sources, it is possible to control the location of concentration.

In another embodiment, the low frequency waves are used for mixing of various substances within a hermetically sealed article to counter the effects of differentiation by settling. According to this embodiment, the low frequency acoustic energy is used for creating a material flow that causes the mixing of species within the article.

There may be many applications where it is not desired to recover trace particles from within a hermetically sealed article, but it is necessary to move particles or other materials inside the hermetically sealed article. A system described herein can accomplish this by the low frequency acoustic wave mechanism as described above. The low frequency acoustic waves cause the walls of the article to vibrate at the same frequency as the incident wave and cause the wave to be created within the article. Hence, the article looks fairly invisible to the acoustic waves. Within the article, the waves create flows in the material, which can be used as a transport mechanism. Properly tuned, the transport mechanism may be used to cause particle separation or sedimentation of materials of differing densities.

In another embodiment, low frequency standing waves are formed within the article. Particles are forced to the antinodes of the standing waves. As the phase of one or more of the standing wave transmitters is varied, the standing wave moves, carrying the particles with it.

It is to be understood that when the particles are denser from the surrounding, the particles are forced to the antinodes of the standing waves. In the opposite case, when bubbles are removed from a liquid (wherein the bubbles may be any material lighter from the surrounding), the bubbles are forced to the nodes of the standing waves.

In another embodiment, low frequency standing waves are formed within an article/container, the article including materials featuring at least two materials having different density. By moving the standing wave within the article, the different materials are separated based on their density. Denser materials will be preferentially moved to the furthest extent of the motion of the antinodes within the container, while less dense materials will be blocked by the denser materials.

In still another embodiment, low frequency standing waves are formed within an article/ container, wherein the article has at least two materials having different size. By moving the standing wave within the article, the different materials are separated based on their size. Smaller sized articles will be forced between the larger sized articles, by the movement of the antinodes.

The devices described above correspond to the methods for using low-frequency acoustic waves for moving particles inside articles, in accordance with the present invention. However, it is to be clearly understood that above described devices are readily extendable and applicable to the following description of exemplary methods.

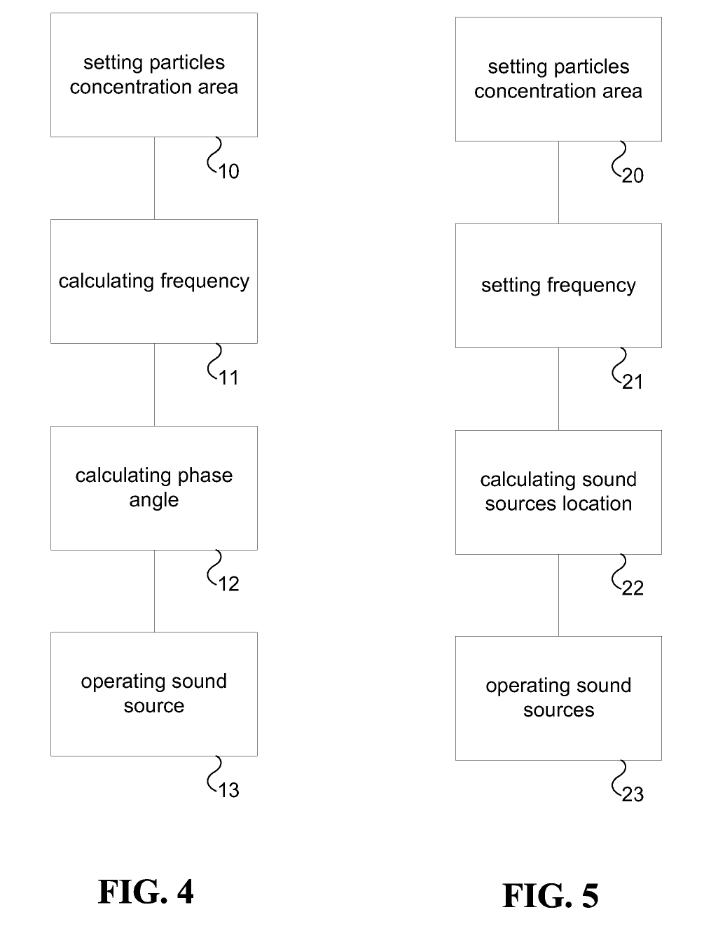

Referring to FIG. 4, featuring steps 10-13, in a particular embodiment of the general method, the following steps are performed using standing waves. Alternatively, the following steps are performed using moving standing waves.

Setting particle concentration area and sound source location.

Alternatively stated, this step establishes the required zone of particle concentration and at least one sound source location. In this step, the required particle concentration area and at least one sound source location are defined. The particle concentration area location is measured preferably in relation to the at least one sound source but may be measured in relation to other reference points.

Calculating the sound source operating frequency.

The sound sources should produce standing waves or moving standing waves. The selected frequency depends on the required distance between the sound sources and the match between the specific frequency and the material upon which the sound waves are applied. Optionally, the frequency may be chosen to satisfy the requirement of not creating sound pollution to human or animal ears.

Calculating the available sound sources appropriate phase angles.

It is to be noted that in this case, the sound sources are already placed around the system and are stationary. The phase angles of the sound sources are calculated as known in the art. Moreover, in case the sound sources are not placed at distances that are discrete multiples of the wavelength, the sound sources may need to reconstruct the required phases of the sound waves in order to produce the required standing wave.

Operating the sound sources at the calculated phase and frequency.

The sound sources are operated as known in the art. The sound sources may be controlled by a controller as known in the art by using an open or closed loop control. Optionally, observing the actual location that the particles move to and recalculating the frequency and phase angles based on the difference between the observed location and the desired location.

Optionally, the sound sources are controlled by a closed loop controller, wherein the close loop controller measures the location that the particles move to. According to that measurement, the controller applies an appropriate correction. It is to be understood that the closed loop measurement can be implemented by any other known in the art measurement mechanisms, such as, but not limited to, optical, conductive, resistive, mass, strain, and observed measurements.

As is known in the art of closed loop control mechanisms, the above measurements are used for correcting the operation of the system. As a result, an updated command is fed into the sound source controller. Before changing the phases, the closed loop may take into account the current phase of the sound sources in order to change the phase in a continuous manner.

Referring to FIG. 5, featuring steps 20-23, in another particular embodiment of the general method, the following steps are performed by physically moving the sound sources instead of tuning the phase angles and/or the frequency.

Setting particle concentration area.

In this step, the at least one required particle concentration area is defined. The particle concentration location may be measured in relation to any appropriate reference point.

Setting the sound sources operating frequency.

In this step, the operating frequency of the sound sources is defined. The operating frequency may be defined independently of the location of the sound sources.

Calculating the appropriate location of the sound sources to be used, so that the anti nodes are at the desired locations.

As known in the art, when applying standing waves to particles, the particles are concentrated towards the anti nodes. When the frequency and the phase are given, the location of the antinodes depends on the distance between the sound sources. In this step, the appropriate distance is calculated and the sound sources are placed according to the result. This step refers to particles which are heavier than their surrounding fluid. Should the particles be lighter, then this step is the same except that nodes of the standing waves are used instead of the antinodes.

Operating the sound sources at the calculated frequency.

The sound sources are operated as known in the art. The sound sources may be controlled by a controller as known in the art by using an open or closed loop control.

Optionally, observing the actual location that the particles move to and recalculating the location of the sound sources.

Optionally, recalculating the location of the at least one sound source based on the difference between the observed location and the desired location of particle concentration.

Thus, it is understood from the embodiments of the invention herein described and illustrated, above, that the method and system for moving particles within an article, of the present invention, are neither anticipated or obviously derived from the prior art. It is appreciated that certain features of the invention, which are, for clarity, described in the context of separate embodiments, may also be provided in various combinations in a single embodiment. Conversely, various features of the invention, which are, for brevity, described in the context of a single embodiment, may also be provided separately or in any suitable sub-combination.

It is to be understood that the present invention is not limited in its application to the details of the order or sequence of steps of operation or implementation of the system and corresponding method set in the description, drawings, or examples of the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

What is claimed is:

1. A device comprising:
(a) at least one sound source,
(b) at least one chamber adapted to hold an article, whereby said at least one sound source causes fluid movement within said at least one article, and said fluid movement induces movement of particles in relation to at least one of the the article and the chamber.

2. The device of claim 1, wherein some of said particles are collected.

3. The device of claim 1, wherein some of said particles are extracted.

4. The device of claim 1, wherein said article comprises at least one compartment and said at least one compartment is hermetically sealed when said device causes said fluid movement within said article.

5. The device of claim 1, wherein said sound source produces frequencies below 20 Hz.

6. The device of claim 1, wherein said sound source produces frequencies in the range of 20 Hz to 20 KHz.

7. The device of claim 1, wherein said sound source produces frequencies above 20 KHz.

8. The device of claim 1, further comprising a particle collection system.

9. The device of claim 8, wherein particles collected by the particle collection system are forwarded to a trace detection system.

10. The device of claim 9, wherein said sound source concentrates some of said particles towards at least one particle collection component of said particle collection system.

11. The device of claim 1, wherein said sound source concentrates particles towards a predefined location.

12. The device of claim 1, wherein the device further comprises a particle-dispersion device, comprising at least one of the following elements: a shaker or other bulk motion mechanism for moving the article in translation, rotation or vibration, a cooler, perhaps down to cryogenic temperatures, a heater, a radiator, a radiation source, a frictional component, an electrostatic component, a field producing component, and an electronic excitation energy device.

13. The device of claim 1, further comprising pressurizing device for increasing an air pressure in the chamber.

14. The device of claim 13, further comprising depressurizing device for decreasing an air pressure in the chamber.

15. A method for collecting particles from an article, the method comprising the steps of:
(a) applying a sound wave to the article, whereby said sound wave disperses particles throughout the article, and
(b) collecting particles from at least one portion of the article.

16. The method of claim 15, wherein the collected particles are analyzed by a trace detection system.

17. The method of claim 15, wherein the step of collecting particles comprises swabbing said article in order to pick up particles.

18. The method of claim 15, wherein the step of collecting particles comprises physical contact between a particle collector and the article.

19. The method of claim 15, wherein the step of collecting particles employs a non-contact particle collector.

20. The method of claim 15, wherein the step of collecting particles comprises pressurizing and depressurizing the article in order to move particles out of the article.

21. The method of claim 15, wherein the step of applying said sound wave is synchronized with the step of collecting particles.

22. The method of claim 15, wherein the sound wave comprises a moving pressure wave.

23. The method of claim 15, wherein the sound wave concentrates particles towards a predefined particle collection location, whereby the collecting particles step selectively acquires particles from the particle collection location.

24. The method of claim 23, further comprising the step of observing the actual location to which the particles move, and correcting at least one of the parameters affecting the sound wave to alter the actual location.

25. The method of claim 15, further comprising the step of auto-calibrating the sound wave by controlling the phase and frequency of the sound wave.

26. The method of claim 15, wherein said method distinguishes between particles having different characteristics, and the step of collecting particles from the article preferentially collects particles having a predefined characteristics.

27. The method of claim 15, wherein said article comprises at least one hermitically sealed compartment, further comprising the step of opening the hermetically sealed compartment.

28. The method of claim 15, wherein the frequency of said sound wave is below 20 Hz.

29. The method of claim 15, wherein the frequency of said sound wave is in the range of 20 Hz to 20 KHz.

30. The method of claim 15, wherein the frequency of said sound wave is above 20 KHz.

31. The method of claim 15, further comprising at least one of the following steps: heating, shaking, and radiating.

32. A method for collecting particles from an article, the method comprising the steps of:
(a) defining at least one particle concentration area and an acoustic transducer configuration;
(b) calculating at least one set of acoustic transducer configuration operational parameters for producing an acoustic wave pattern adapted to move least one particle; and
(c) operating the acoustic transducer configuration in accordance with the calculated set of acoustic transducer configuration parameters, to preferentially concentrate particles at the at least one particle concentration area.

33. The method of claim 32, further comprising the step of transporting the particles to a trace detection system at least in part acoustically.

34. The method of claim 32, further comprising the step of observing the actual location to which the particles move, and correcting the at least one set of acoustic transducer configuration operational parameters.

35. The method of claim 32, wherein the acoustic transducer configuration has at least one output waveform, further comprising the step of modifying at least one of the output waveforms to alter the collection of particles,

36. The method of claim 32, wherein the particle concentration area is within an enclosed chamber, further comprising the step of selectively transporting particles from the at least one particle concentration area out of the enclosed chamber.

37. The method of claim 36, wherein the step of selectively transporting particles comprises carrying the particles within a flow of a gas or fluid.

38. The method of claim 32, wherein the step of collecting particles comprises selectively pressurizing and depressurizing the article in order to move particles within the article.

39. The method of claim 32, wherein the step of operating the acoustic transducer configuration is synchronized with the step of collecting particles.

40. The method of claim 32, wherein the article comprises at least one compartment, further comprising the step of opening the compartment.

41. The method of claim 32, wherein said sound source operating frequency is below 20 Hz.

42. The method of claim 32, further comprising at least one treatment selected from the group of: shaking, causing bulk motion of the article to induce translation, rotation, vibration, cooling, heating, radiating, and applying an electrostatic field and applying an electromagnetic field

43. The method of claim 32, wherein the at least one set of acoustic transducer configuration operational parameters comprises at least one acoustic frequency.

44. The method of claim 32, wherein the at least one set of acoustic transducer configuration operational parameters comprises at least one selected position of an acoustic element.

45. The method of claim 32, wherein the at least one set of acoustic transducer configuration operational parameters comprises at least one acoustic transducer position.

46. The method of claim 32, wherein said calculating step determines at least one anti-node of a sound wave.

47. The method of claim 32, further comprising the step of observing an actual location to which the particles preferentially concentrate, recalculating the at least one set of acoustic transducer configuration operational parameters in dependence thereon, and operating the acoustic transducer configuration in dependence on the recalculation.
